(19) United States
(12) Patent Application Publication
(10) Pub. No.: US 2010/0039018 A1
(43) Pub. Date: Feb. 18, 2010

(54) HOT CATHODE LOW PRESSURE DISCHARGE LAMP

(76) Inventor: Katsushi Seki, Shiga (JP)

Correspondence Address: SNELL & WILMER L.L.P. (Panasonic), 600 ANTON BOULEVARD, SUITE 1400, COSTA MESA, CA, 92626, US

(21) Appl. No.: 12/442,517

(22) PCT Filed: Sep. 26, 2007
(86) PCT No.: PCT/JP2007/068689

§ 371 Date: Mar. 24, 2009

(30) Foreign Application Priority Data
Sep. 28, 2006 (JP) 2006-266034

(51) Int. Cl. H01J 5/02

(52) U.S. Cl. 313/317

(57) ABSTRACT

A spontaneous break in a glass tube can be sufficiently suppressed in a hot cathode low pressure discharge lamp. A hot cathode low pressure discharge lamp (10) includes a glass tube (1) in which a filament (2) is arranged. The glass tube (1) has a cross section that is flat in configuration, and a flattening x and a thickness ratio T satisfy the below expression, where the flattening x is a ratio A/B between a major diameter A and a minor diameter B of the cross section of the glass tube, the thickness ratio T is a ratio t/A between a thickness t of the glass tube and the major diameter A of the cross section of the glass tube, a=−0.809, b=0.728, c=−3.46, d=−0.0689, e=0.926, and f=−2.12.

$$0 < exp ( \frac{a}{{( x - 1 )}^{b}} + c ) \times {T}^{( \frac{d}{{( x - 1 )}^{e}} + f )} ≦ 15$$

### TECHNICAL FIELD

The present invention relates to a hot cathode low pressure discharge lamp, and in particular to a configuration of a transverse cross section of a glass tube.

### BACKGROUND ART

In recent years, there has been a rapid increase in the size of liquid crystal televisions and consequently a rapid increase in the size of backlight devices. Accordingly, consideration has begun to be given to replacing current cold cathode low pressure discharge lamps, which are used as light sources in backlight devices, with hot cathode low pressure discharge lamps that are superior in terms of lamp efficiency and cost reduction.

When applying a hot cathode low pressure discharge lamp to a backlight device, the large diameter of the glass tube constituting the lamp becomes an issue. Since electrodes in a hot cathode low pressure discharge lamp are larger than electrodes in a cold cathode low pressure discharge lamp, the diameter of the glass tube is commensurately larger in a hot cathode low pressure discharge lamp than in a cold cathode low pressure discharge lamp. For example, the diameter of a glass tube in a cold cathode low pressure discharge lamp is 3 to 5 mm, whereas even in a slim type of hot cathode low pressure discharge lamp for general lighting, the diameter of the glass tube is roughly 15 mm. Note that use in a backlight requires a longer lamp lifetime than use for general lighting. In view of this, an even larger electrode must be provided in the case of use in a backlight, which would lead to the glass tube having an even larger diameter. Depending on the required lifetime, it is highly possible for the diameter of the glass tube to be 20 mm or more.

As the diameter of the glass tube increases, there is an increase in the thickness of an optical unit that causes light emitted from the lamp to irradiate a liquid crystal panel evenly, thus increasing the depth of the liquid crystal television and lowering the commercial value.

In order to solve this problem, consideration has been given to a lamp including a glass tube whose cross section is flat in configuration. Specifically, the electrodes of such a lamp are arranged in the major diameter direction of the glass tube, and the lamp is arranged in a backlight device so that the minor diameter direction of the glass tube conforms to the thickness direction of the back light device, in an attempt to achieve both an extended lamp lifetime and a thin backlight device. Note that regarding circular fluorescent lamps for general lighting, patent document 1 discloses technology for achieving a glass tube whose cross section is flat in configuration in order to improve the illuminance of an irradiated surface.

Patent document 1: Japanese Patent Publication No. 2624653

### DISCLOSURE OF THE INVENTION

### Problems Solved by the Invention

Since the inner pressure of a low pressure discharge lamp is lower than the outside atmospheric pressure, stress occurs in the glass tube constituting the lamp due to the difference in pressure inside and outside the glass tube. If the glass tube has a circular cross section, compressive stress occurs evenly in the circumference direction of the glass tube, while no tensile stress occurs. Since glass is highly resistant to compressive stress, glass tubes that have a circular cross section very rarely break due to the difference in pressure inside and outside the glass tube. On the other hand, if the glass tube has a flat cross section, tensile stress occurs in the glass tube in the circumference direction of the cross section due to the difference in pressure inside and outside the glass tube. Since the tensile strength of glass is lower than its compressive strength, the glass tube of a flat lamp readily breaks spontaneously after lamp manufacture.

Note that the stress that occurs in the glass tube is thought to be determined according to a flattening x of the glass tube (a ratio A/B between a major diameter A and a minor diameter B of the cross section of the glass tube) and a thickness ratio T (a ratio t/A between a thickness t of the glass tube and the major diameter A of the cross section of the glass tube). However, it was not previously known what condition must be satisfied by the flattening x and thickness t in order to sufficiently suppress a spontaneous break in the glass tube.

In the case of simply lowering the possibility of a spontaneous break, increasing the thickness of the glass tube raises the strength of the glass tube, thus preventing spontaneous breaks in the glass tube. However, increasing the thickness of the glass tube has disadvantages such as the following.

Firstly, distortion readily occurs during glass processing steps such as the formation of the flat configuration and the formation of sealing portions, and a reduction in strength can occur due to such distortion. Also, there is an increase in the amount of heat required for glass processing, thus raising the amount of energy required for processing, which consequently lowers mass productivity that includes production energy efficiency. Furthermore, the lamp becomes heavier, thus creating a need to, for example, raise the support strength of support means for fixing the lamp to the optical unit.

Accordingly, it is necessary to reduce the thickness of the glass tube as much as possible while ensuring a strength that is sufficient to prevent spontaneous breaks.

In view of the above, an object of the present invention is to disclose the above-mentioned condition that must be satisfied, and provide a low pressure discharge lamp that sufficiently suppresses spontaneous breaks in a glass tube by satisfying the condition.

### Means to Solve the Problems

One aspect of the present invention is a hot cathode low pressure discharge lamp, wherein a cross section of the glass tube is flat in configuration, and a flattening x and a thickness ratio T satisfy the following expression, the flattening x being a ratio A/B between a major diameter A and a minor diameter B of the cross section of the glass tube, the thickness ratio T being a ratio t/A between a thickness t of the glass tube and the major diameter A of the cross section of the glass tube, a=−0.809; b=0.728, c=−3.46, d=−0.0689, e=0.926, and f=−2.12.

$$0 < exp ( \frac{a}{{( x - 1 )}^{b}} + c ) \times {T}^{( \frac{d}{{( x - 1 )}^{e}} + f )} ≦ 15 \qquad ( Expression )$$

### EFFECTS OF THE INVENTION

It was discovered that the above structure enables sufficiently suppressing spontaneous breaks in the glass tube. The reason for this is described in detail in the section “Best Mode for Carrying Out the Invention”.

Also, the flattening x may be in a range of 1.1 to 2.4 inclusive.

This structure enables obtaining a low pressure discharge lamp that is suitable for use in a backlight device. The reason for this is described in detail in the section “Best Mode for Carrying Out the Invention”.

Also, the major diameter A may be 17 mm or more, and the minor diameter B may be in a range of 8 mm to 21 mm inclusive.

Lamp lifetime and the size of the electrodes (hot cathode filament coils) are in the following relationship: the longer the lamp lifetime that is required, the larger the electrodes must be. Setting the major diameter A to 17 mm or more and the minor diameter B to 8 mm or more, as in the above structure, enables the glass tube to contain electrodes having a size necessary to ensure a lamp lifetime (40,000 hours) that is comparable to current CRT devices. Furthermore, backlight devices in large liquid crystal televisions that use current cold cathode lamps have a thickness of 25 to 30 mm. If a lamp having a large minor diameter is used in a backlight device that has such a thickness, the distance between the lamp and the optical sheet provided in the backlight device becomes smaller, and the brightness becomes uneven. Setting the minor diameter to 21 mm or less enables suppressing the unevenness in brightness to a practical level.

Also, the major diameter A may be 20 mm or more.

This structure enables the glass tube to contain electrodes having a size necessary to ensure a lamp lifetime (60,000 hours) that is comparable to cold cathode fluorescent lamps used in current liquid crystal backlight devices.

Also, the major diameter A may be 23 mm or more.

This structure enables the glass tube to contain electrodes having a size necessary to ensure a lamp lifetime (80,000 hours) that is longer than cold cathode fluorescent lamps.

Also, the minor diameter B may be 16 mm or less.

When applied in a backlight device, this structure enables reducing unevenness in brightness to a desirable level.

Also, a difference between the major diameter A and the minor diameter B may be 5 mm or more.

When applied in a backlight device, this structure enables a reduction of 5 mm or more in the thickness of the backlight device.

Also, the flat configuration may be a substantially elliptical configuration.

According to this structure, the curvature of the cross section varies continuously, thereby facilitating optical design of backlight devices.

### BRIEF DESCRIPTION OF THE DRAWINGS

FIG. 1 shows an external appearance and configuration of a fluorescent lamp of the present invention;

FIG. 2 shows test specifications and contour lines of maximum stress occurring in a glass tube of the fluorescent lamp;

FIG. 3 shows remaining rates after manufacture of the fluorescent lamp; and

FIG. 4 shows ranges of measurements for the fluorescent lamp of the present invention.

### DESCRIPTION OF THE CHARACTERS

1 glass tube
1a, 1b glass tube end portion
2 filament coil
3 lead wire

### BEST MODE FOR CARRYING OUT THE INVENTION

An embodiment of the present invention is described below with reference to the drawings.

Structure

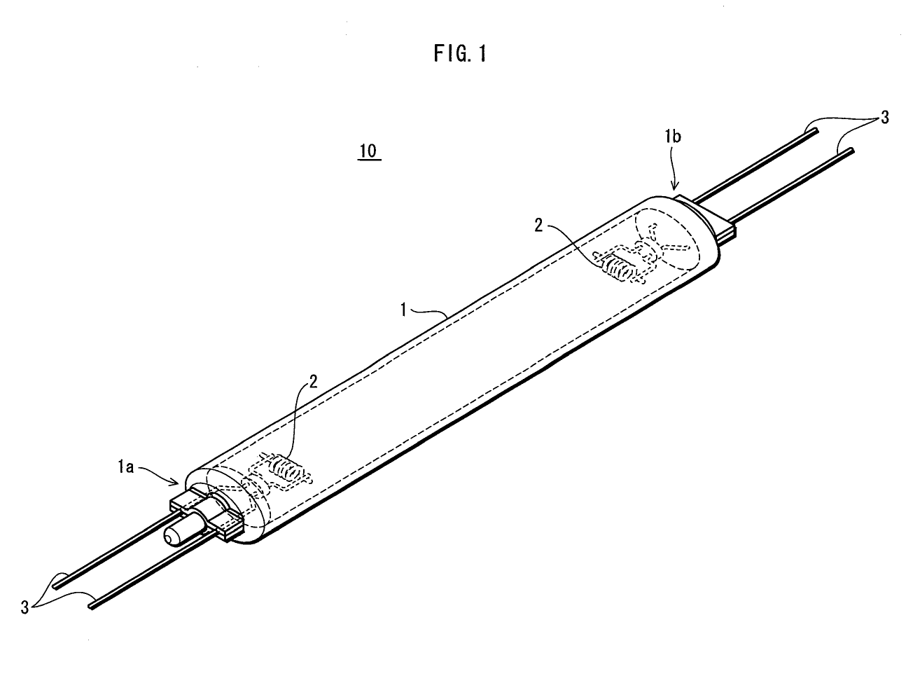

FIG. 1 shows an external appearance and configuration of a fluorescent lamp pertaining to the embodiment of the present invention. A fluorescent lamp 10 of the present embodiment is a hot cathode low pressure discharge lamp including a glass tube 1 in which filaments (or filament coils) 2 are arranged.

The fluorescent lamp 10 of the present embodiment is a straight-tube lamp that is 1,100 mm long, has a thickness of 1.0 mm, and has a transverse cross section that is substantially elliptical in configuration. The transverse cross section has a major diameter A of 24 mm and a minor diameter B of 15 mm. Note that the major diameter A and minor diameter B are based on the outer diameter of the glass tube 1.

The glass may be soda glass or lead-free glass. A phosphor coating has been formed on the inner surface of the glass tube 1, and enclosed in the glass tube 1 are several mg of mercury and 600 Pa of an argon/krypton mixed gas. An electrode composed of two lead wires 3 and a filament coil 2 spanning therebetween has been provided at each of ends 1a and 1b of the glass tube 1.

The following is a first feature of the fluorescent lamp of the present invention. Letting x be a flattening that is a ratio A/B between the major diameter A and minor diameter B of the cross section of the glass tube 1, letting T be a thickness ratio that is a ratio t/A between a thickness t of the glass tube and the major diameter A of the glass tube cross section, and letting a=−0.809, b=0.728, c=−3.46, d=−0.0689, e=0.926, and f=−2.12, the flattening x and the thickness ratio T satisfy the following condition 1.

$$0 < exp ( \frac{a}{{( x - 1 )}^{b}} + c ) \times {T}^{( \frac{d}{{( x - 1 )}^{e}} + f )} ≦ 15 \qquad ( Expression 1 )$$

Satisfying condition 1 enables sufficiently suppressing spontaneous breaks in the glass tube 1. In other words, a suppression means for suppressing a spontaneous break in the glass tube is realized by satisfying condition 1. The following describes details of the reason why spontaneous breaks in the glass tube 1 can be suppressed.

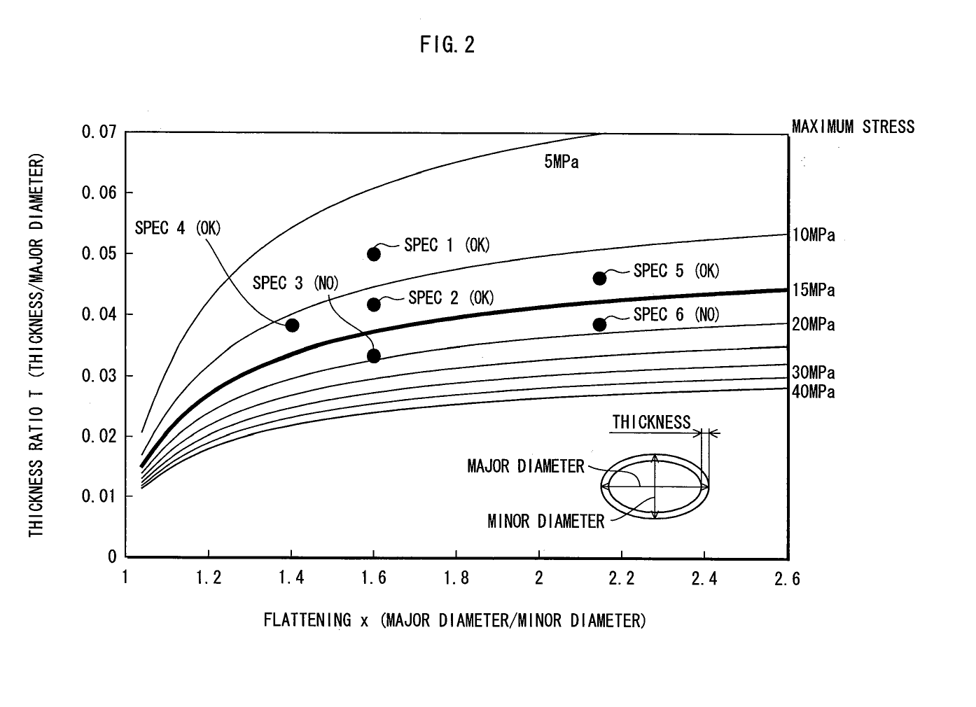

FIG. 2 shows test specifications and contour lines of maximum stress occurring in the glass tube of the fluorescent lamp.

Using general-purpose finite element analysis software (COSMOS Works (registered trademark), SolidWorks Corp.), the inventor of the present invention set the flattening x and thickness ratio T as parameters and calculated a maximum stress σ. For each flattening x, σ was fit to σ=C×TD, C and D were fit to C=exp(a/(x−1)̂b+c) and D=d/(x−1)̂e+f. This resulted in the following relational expression.

$$σ = exp ( \frac{a}{{( x - 1 )}^{b}} + c ) \times {T}^{( \frac{d}{{( x - 1 )}^{e}} + f )} \qquad ( Expression 2 )$$

a=−0.809, b=0.7.28, c=−3.46, d=−0.0689, e=0.926, and f=−2.12

In FIG. 2, maximum stresses σ that satisfy the above relational expression are shown in 5 MPa intervals from 5 MPa to 40 MPa.

Also, the inventor of the present invention manufactured 200 fluorescent lamps for each of specifications 1 to 4 shown below and 100 fluorescent lamps for each of specifications 5 and 6 shown below, and performed an experiment in which the manufactured lamps were left under atmospheric pressure and the number of remaining lamps that had not spontaneously broken were counted every seven days. The specifications were as shown below in table 1.

TABLE 1

| | Major | Minor | | | |
|---|---|---|---|---|---|
| | diameter A of | diameter B | | | |
| | tube cross | of tube cross | | | Thickness |
| Item | section | section | Flattening x | Thickness t | ratio T |
| Specification 1 | 24 | 15 | 1.60 | 1.2 | 0.050 |
| Specification 2 | 24 | 15 | 1.60 | 1.0 | 0.042 |
| Specification 3 | 24 | 15 | 1.60 | 0.8 | 0.033 |
| Specification 4 | 21 | 15 | 1.40 | 0.8 | 0.038 |
| Specification 5 | 26 | 12 | 2.17 | 1.2 | 0.046 |
| Specification 6 | 26 | 12 | 2.17 | 1.0 | 0.038 |

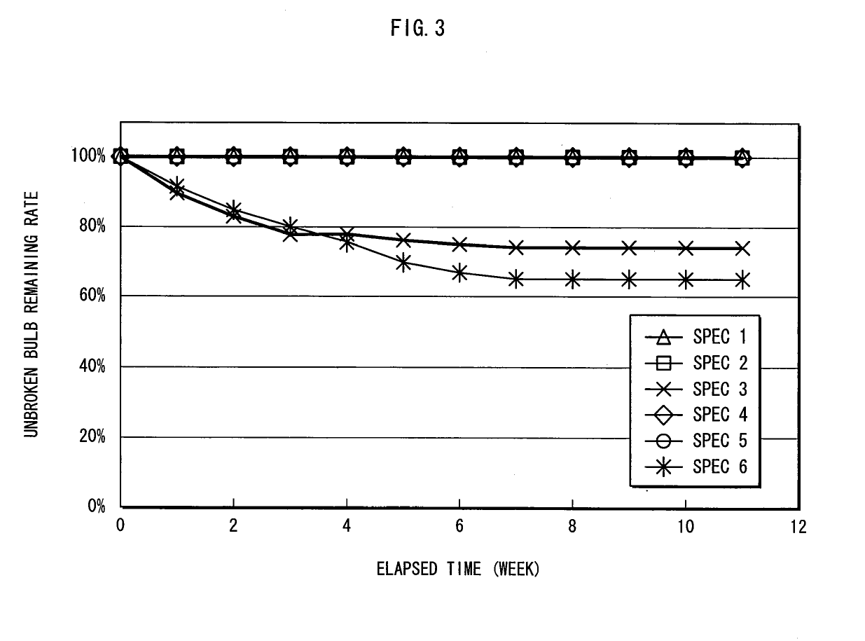

As shown in FIG. 3, the remaining rate for specifications 1, 2, 4, and 5 was maintained at 100% even at 10 weeks since lamp manufacture, whereas the remaining rates for specifications 3 and 6 fell to approximately 75% and 65% respectively at 10 weeks since lamp manufacture. Specifications that can maintain a remaining rate of 100% are suitable as product specifications for fluorescent lamps. It was therefore discovered that specifications 1, 2, 4, and 5 are applicable as product specifications, whereas specifications 3 and 6 are not desirable as product specifications.

If specifications 1 to 6 are plotted on the contour line graph of FIG. 2, specifications 1, 2, 4, and 5 that are applicable as product specifications fall in an area where the maximum stress is 10 MPa to 15 MPa, and specifications 3 and 6 that are not applicable fall in an area where the maximum stress is 15 MPa to 20 MPa. This demonstrates that spontaneous breaks in the glass tube 1 can be sufficiently suppressed if the maximum stress is 15 MPa or less. In consideration of the fact that stress occurring in the glass tube is the main cause for spontaneous breaks, spontaneous breaks can be suppressed when using other flattenings as long as the maximum stress is 15 MPa or less. Therefore, satisfying condition 1 enables sufficiently suppressing spontaneous breaks in the glass tube 1.

In other words, according to the fluorescent lamp 10 of the present embodiment, satisfying condition 1 enables sufficiently suppressing spontaneous breaks in the glass tube 1, thereby eliminating the need to provide a new member (e.g., a reinforcing member) to suppress spontaneous breaks in the glass tube 1.

Additionally, the present embodiment avoids increasing the thickness of the glass tube more than necessary, thereby having advantages such as the following.

Specifically, when the thickness of the glass tube is larger than necessary, distortion readily occurs during glass processing steps such as the formation of the flat configuration and the formation of sealing portions, and a reduction in strength can occur due to such distortion. However, this problem can be prevented or mitigated by avoiding a larger-than-necessary increase in the thickness of the glass tube. Also, when the thickness of the glass tube is larger than necessary, there is an increase in the amount of heat required for glass processing, thus raising the amount of energy required for processing, which consequently lowers mass productivity that includes production energy efficiency. However, this problem can be prevented or mitigated by avoiding a larger-than-necessary increase in the thickness of the glass tube.

Furthermore, when the thickness of the glass tube is larger than necessary, the lamp becomes heavier, thus creating a need to, for example, raise the support strength of support means for fixing the lamp to the optical unit. However, this problem can be avoided or mitigated by avoiding a larger-than-necessary increase in the thickness of the glass tube.

Also, a second feature of the fluorescent lamp of the present invention is that condition 2 is satisfied. Condition 2 is that the flattening x is in a range of 1.1 to 2.4 inclusive, the major diameter A is 17 mm or more, and the minor diameter B is in a range of 8 mm to 21 mm inclusive.

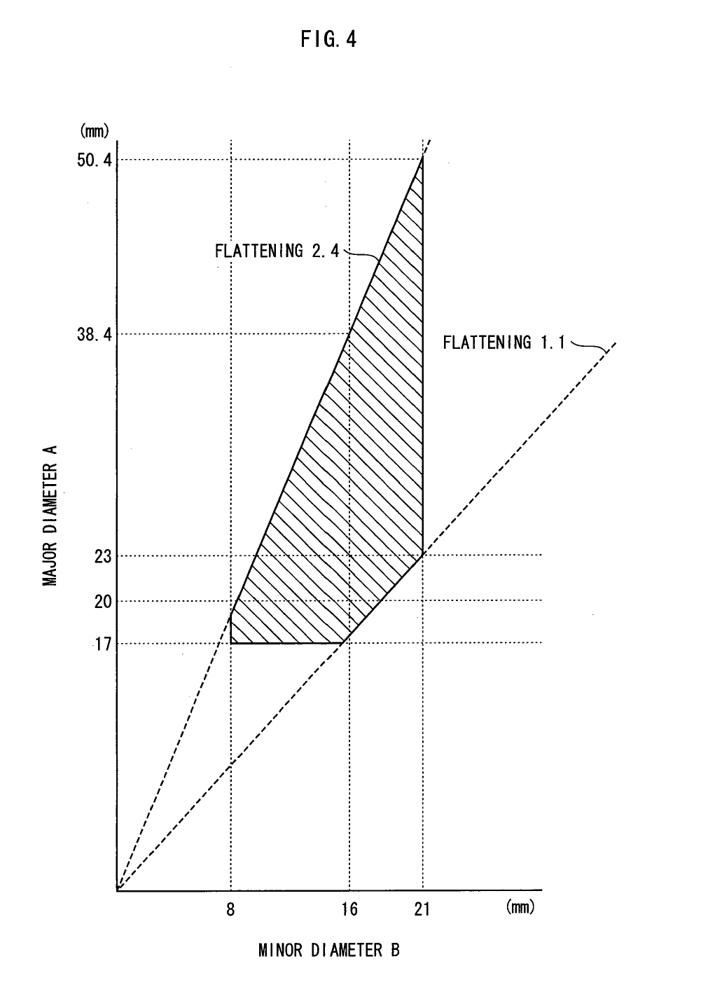

FIG. 4 shows ranges of measurements for the fluorescent lamp of the present invention.

In FIG. 4, the vertical axis represents the major diameter A, the horizontal axis represents the minor diameter B, and flattenings x are represented by the slopes of straight lines that pass through the origin. The hatched area in FIG. 4 shows the range of measurements that satisfy condition 2. Satisfying condition 2 enables obtaining a fluorescent lamp that is suitable for use in a backlight device. Grounds for this are described below.

Giving the cross section of the glass tube a flat configuration enables improving the illuminance of the front face of the lamp. In particular, setting the flattening to 1.1 or more enables raising the illuminance of the front face of the lamp to a desirable level. Furthermore, setting the flattening of the cross section of the glass tube to 1.1 or more enables reducing the thickness of a backlight device 10% or more compared to a case in which the glass tube has a circular cross section (a flattening of 1). Also, glass tube formation processing becomes difficult when the flattening of the glass tube is over 2.4. In view of this, setting the flattening of the glass tube to 2.4 or less facilitates glass tube formation processing.

Lamp lifetime and the size of the electrodes are in the following relationship: the longer the lamp lifetime that is required, the larger the electrodes must be. When using fluorescent lamps in a backlight device, it is necessary to ensure at least a lamp lifetime (40,000 hours) that is comparable to current CRT devices. Setting the major diameter A of the glass tube to 17 mm or more and the minor diameter B of the glass tube to 8 mm or more enables the glass tube to contain electrodes having a size necessary to ensure a lamp lifetime comparable to CRT devices.

Backlight devices in large liquid crystal televisions that use current cold cathode lamps have a thickness of 25 to 30 mm. If a lamp having a large minor diameter is used in a backlight device have such a thickness, the distance between the lamp and the optical sheet provided in the backlight device becomes smaller, and the brightness becomes uneven. Setting the minor diameter to 21 mm or less enables suppressing the unevenness in brightness to a practical level.

Note that setting the major diameter A of the glass tube to 20 mm or more enables ensuring a lamp lifetime (60,000 hours) that is comparable to cold cathode low pressure discharge lamps, and setting the major diameter A of the glass tube to 23 mm or more enables ensuring a lamp lifetime (80,000 hours) that is longer than cold cathode low pressure discharge lamps, which is even more preferable.

Also, setting the minor diameter B of the glass tube to 16 mm or less enables suppressing unevenness in brightness to a desirable level.

Also, setting the difference between the major diameter A and minor diameter B of the glass tube to 5 mm or more enables a reduction of 5 mm or more in the thickness of the backlight device, which is preferable.

Manufacturing Method

The following describes a manufacturing method for the fluorescent lamp of the present invention.

The manufacturing method for the fluorescent lamp 10 is similar to a manufacturing method for a general fluorescent lamp, with the exception of including flattening processing. Specifically, a phosphor material is applied to a glass tube, the phosphor material is sintered, flattening processing is performed, the ends of the glass tube are pinch-sealed, the interior of the glass tube is evacuated, and a gas and mercury are enclosed in the evacuated glass tube. The flattening processing involves, after sintering the phosphor material (600-650° C.), further raising the temperature (650-700° C.) to soften the glass, and then performing molding using a metallic die.

Although a fluorescent lamp of the present invention has been described above based on the embodiment, the present invention is not limited to the above embodiment.

(1) The tensile stress that occurs in a flat glass tube is proportional to the difference in pressure inside and outside the lamp. However, the inner pressure of a low pressure discharge lamp is normally 100 Pa to 1 kPa, and at most roughly 10 kPa, which is 10% or less of the outer pressure (atmospheric pressure) that is approximately 100 kPa. As such, even when individual variations in glass strength and variations in atmospheric pressure are taken into consideration, the inner pressure has little influence. Accordingly, the content recited in the embodiment is applicable to low pressure discharge lamps in general, regardless of the inner pressure of the lamp. It should also be noted that the difference between the inner and outer pressure was set to atmospheric pressure (100 kPa) when calculating stress.

(2) The maximum stress was calculated in cases of glass tubes having elliptical cross sections. Maximum stress was calculated in cases of several other types of flat configurations such as an oval, but the difference in each case was 10% or less. This amount of difference is small compared to individual variations in glass strength. Accordingly, the content recited in the embodiment is applicable to flat configurations other than an ellipse.

(3) Embodiment 1 describes a fluorescent lamp under the assumption of use in a backlight. However, the present invention is not limited to this, as long as the glass cross section is flat. For example, the present invention may be used in a flat type of general lighting apparatus.

(4) In the embodiment, soda glass and lead-free glass are recited as examples of the type of glass that constitutes the flat glass tube. However, the present invention is not limited to soda glass or lead-free glass since the difference in strength between types of glass is considered to be within the margin of error when compared to individual variations in glass strength. Rather than being limited to soda glass or lead-free glass, the type of glass used in the present invention may be selected appropriately in consideration of cost, workability, etc.

### INDUSTRIAL APPLICABILITY

A backlight device is one example of a use for the present invention.

1. A hot cathode low pressure discharge lamp including a glass tube in which a filament is arranged, wherein
a cross section of the glass tube is flat in configuration, and
a flattening x and a thickness ratio T satisfy the following expression
$$0 < exp ( \frac{a}{{( x - 1 )}^{b}} + c ) \times {T}^{( \frac{d}{{( x - 1 )}^{e}} + f )} ≦ 15$$
the flattening x being a ratio A/B between a major diameter A and a minor diameter B of the cross section of the glass tube, the thickness ratio T being a ratio t/A between a thickness t of the glass tube and the major diameter A of the cross section of the glass tube, a=−0.809, b=0.728, c=−3.46, d=−0.0689, e=0.926, and f=−2.12.

2.-9. (canceled)

10. The hot cathode low pressure discharge lamp of claim 1, wherein
the flattening x is in a range of 1.1 to 2.4 inclusive.

11. The hot cathode low pressure discharge lamp of claim 10, wherein
the major diameter A is 17 mm or more, and
the minor diameter B is in a range of 8 mm to 21 mm inclusive.

12. The hot cathode low pressure discharge lamp of claim 11, wherein
the major diameter A is 20 mm or more.

13. The hot cathode low pressure discharge lamp of claim 12, wherein
the major diameter A is 23 mm or more.

14. The hot cathode low pressure discharge lamp of claim 11, wherein
the minor diameter B is 16 mm or less.

15. The hot cathode low pressure discharge lamp of claim 11, wherein
a difference between the major diameter A and the minor diameter B is 5 mm or more.

16. The hot cathode low pressure discharge lamp of claim 1, wherein
the major diameter A is 17 mm or more, and
the minor diameter B is in a range of 8 mm to 21 mm inclusive.

17. The hot cathode low pressure discharge lamp of claim 1, wherein
the flat configuration is a substantially elliptical configuration.

18. A hot cathode low pressure discharge lamp comprising:
a glass tube;
a filament arranged in the glass tube; and
a suppression means for suppressing a spontaneous break in the glass tube, wherein
a cross section of the glass tube is flat in configuration, and
the suppression means is realized by a flattening x and a thickness ratio T satisfying the following expression
$$0 < exp ( \frac{a}{{( x - 1 )}^{b}} + c ) \times {T}^{( \frac{d}{{( x - 1 )}^{e}} + f )} ≦ 15$$
the flattening x being a ratio A/B between a major diameter A and a minor diameter B of the cross section of the glass tube, the thickness ratio T being a ratio t/A between a thickness t of the glass tube and the major diameter A of the cross section of the glass tube, a=−0.809, b=0.728, c=−3.46, d=−0.0689, e=0.926, and f=−2.12.

19. The hot cathode low pressure discharge lamp of claim 18, wherein
the flattening x is in a range of 1.1 to 2.4 inclusive.

20. The hot cathode low pressure discharge lamp of claim 19, wherein
the major diameter A is 17 mm or more, and
the minor diameter B is in a range of 8 mm to 21 mm inclusive.

21. The hot cathode low pressure discharge lamp of claim 20, wherein
the major diameter A is 20 mm or more.

22. The hot cathode low pressure discharge lamp of claim 21, wherein
the major diameter A is 23 mm or more.

23. The hot cathode low pressure discharge lamp of claim 20, wherein
the minor diameter B is 16 mm or less.

24. The hot cathode low pressure discharge lamp of claim 20, wherein
a difference between the major diameter A and the minor diameter B is 5 mm or more.

25. The hot cathode low pressure discharge lamp of claim 18, wherein
the major diameter A is 17 mm or more, and
the minor diameter B is in a range of 8 mm to 21 mm inclusive.

26. The hot cathode low pressure discharge lamp of claim 18, wherein
the flat configuration is a substantially elliptical configuration.
